(19) United States
(12) Patent Application Publication
(10) Pub. No.: US 2024/0279085 A1
(43) Pub. Date: Aug. 22, 2024

(54) PROCESS OF REMOVING ALUMINUM WASTE IN WASTEWATER

(71) Applicant: SK INNOVATION CO., LTD., Seoul (KR)

(72) Inventor: Jae Yang SONG, Daejeon (KR)

(21) Appl. No.: 18/435,055

(22) Filed: Feb. 7, 2024

(30) Foreign Application Priority Data
Feb. 9, 2023 (KR) 10-2023-0017467

(51) Int. Cl. C02F 1/52; C02F 101/10; C02F 103/16

(52) U.S. Cl. CPC C02F 1/5236; C02F 2101/10; C02F 2103/16; C02F 2209/02; C02F 2209/44; C02F 2301/046; C02F 2303/18

(57) ABSTRACT

According to embodiments of the present disclosure, there is provided a process of removing aluminum waste from wastewater. The process includes (a) supplying, as a feed, wastewater containing aluminum; (b) separating the wastewater into a liquid component and a sludge component containing the aluminum; (c) reacting the sludge component with sulfuric acid to produce aluminum sulfate; (d) mixing the aluminum sulfate with alcohol to produce aluminum sulfate hydrate; and (e) adding the aluminum sulfate hydrate produced in step (d) to the wastewater of step (a) and/or to another wastewater. The process can cost-effectively remove waste from wastewater and reduce the content of waste contained in the effluent from being discharged.

### CROSS REFERENCE TO RELATED APPLICATION

The present application claims priority to Korean Patent Application No. 10-2023-0017467, filed Feb. 9, 2023, the entire content of which is incorporated herein by reference.

### FIELD OF THE DISCLOSURE

The present disclosure relates to a process of removing aluminum waste from wastewater.

### DESCRIPTION OF THE RELATED ART

Inorganic coagulants are chemicals that neutralize the surface charge of organic and inorganic colloidal particles contained in wastewater, thereby coagulating and settling the colloidal particles to facilitate the removal thereof. Inorganic coagulants have been used in the field of wastewater treatment. A coagulant containing aluminum sulfate, such as aluminum sulfate hydrate (also called alum), is a typical inorganic coagulant used in wastewater treatment. Wastewater from various industries, such as wastewater from the aluminum anodizing industry, wastewater from construction sites, and wastewater from the treatment process of used batteries, contains aluminum. To discharge industrial wastewater into the environment, such as soil, lakes, river, streams, and oceans, it is desirable to remove aluminum and other pollutants from the industrial wastewater. In this regard, inorganic coagulants are useful to remove aluminum and pollutants from wastewater.

### SUMMARY OF THE DISCLOSURE

The present disclosure relates to a process of removing aluminum waste from wastewater.

A process of removing aluminum waste from wastewater, according to a first aspect of the present disclosure, includes: (a) supplying, as a feed, wastewater containing aluminum; (b) separating the wastewater into a liquid component and a sludge component containing the aluminum; (c) reacting the sludge component and sulfuric acid to produce aluminum sulfate; (d) mixing the aluminum sulfate with an alcohol to produce aluminum sulfate hydrate; and (e) adding the aluminum sulfate hydrate produced in step (d) to the wastewater of step (a) and/or another wastewater.

According to one embodiment, in the supplying of wastewater (step (a)), the wastewater may have an aluminum content of more than 15 wt %.

According to one embodiment, the aluminum waste may include boehmite (AlOOH).

According to one embodiment, the separating of the wastewater into a liquid component and a sludge component (step (b)) may comprise adding externally sourced aluminum sulfate hydrate to the wastewater.

According to one embodiment, the reacting of the sludge component with sulfuric acid (step (c)) may be performed with the use of a sulfuric acid solution having a concentration of 1 M and at a temperature of 60° C. to 100° C. for 1 to 5 hours.

According to one embodiment, the sludge component may be added in an amount of 5 to 15 wt % based on the weight of the sulfuric acid solution.

According to one embodiment, in the mixing of the aluminum sulfate with alcohol (step (d)), the alcohol may comprise ethanol, propanol, butanol, or a combination thereof.

According to one embodiment, in the mixing of the aluminum sulfate with alcohol (step (d)), the aluminum sulfate and the alcohol may be mixed in a volume ratio of 1:2 to 1:5.

According to one embodiment, in the adding of the aluminum sulfate hydrate to the wastewater (step (e)), the aluminum sulfate hydrate may be added in an amount of 10 to 300 ppm relative to the mass of the wastewater.

According to one embodiment, the another wastewater may be in a separate wastewater treatment plant.

According to one embodiment, step (c) may include mixing the sludge component reacts with the sulfuric acid according to the following Reaction Formula 1:

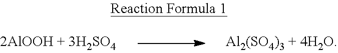

According to the first aspect of the present disclosure, aluminum waste can be removed environment-friendly and cost-effectively.

### BRIEF DESCRIPTION OF THE DRAWINGS

FIG. 1 is a flowchart of a process of removing aluminum waste from wastewater, according to one embodiment;

FIG. 2 is a schematic diagram illustrating a process of regenerating aluminum sulfate, according to one embodiment;

FIG. 3 is a diagram illustrating change in the amount of aluminum hydroxide produced as a function of reaction time between a sludge component and sulfuric acid, according to one embodiment;

FIG. 4 shows FT-IR measurements of aluminum hydroxide and potassium aluminum sulfate that are obtained in one embodiment; and

FIG. 5 is a diagram illustrating the difference in appearance between aluminum sulfate-fed wastewater according to one embodiment and raw wastewater.

### DESCRIPTION OF THE EMBODIMENTS

The above and other objectives, features, and advantages of the present disclosure will be more clearly understood from the following detailed description taken in conjunction with the accompanying drawings, but the present disclosure is not limited thereto. In describing the present disclosure, when the detailed description of the relevant known technology is determined to unnecessarily obscure the gist of the present disclosure, the detailed description may be omitted.

Hereinafter, the embodiments of the present disclosure will be described in detail with reference to the accompanying drawings.

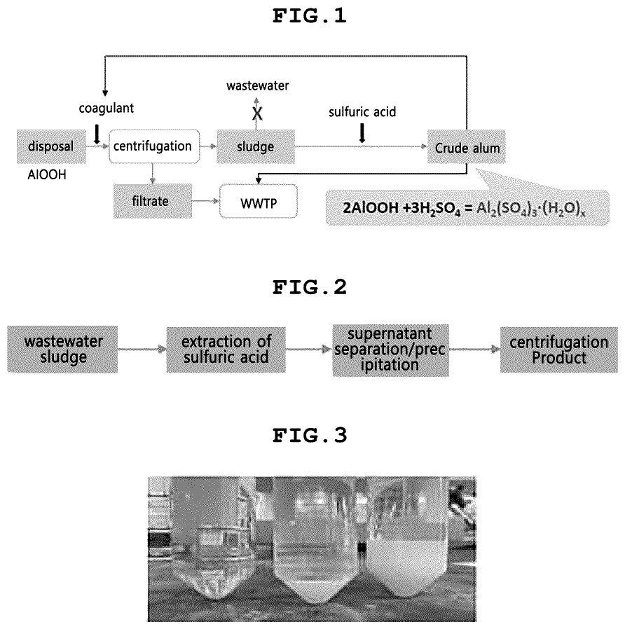

FIG. 1 is a flowchart of a process of removing aluminum waste from wastewater, according to one embodiment. The process of removing aluminum waste from wastewater includes: (a) supplying, as a feed, wastewater containing aluminum; (b) separating the wastewater into a liquid component and a sludge component containing the aluminum; (c) reacting the sludge component with sulfuric acid to produce aluminum sulfate; (d) mixing the aluminum sulfate with an alcohol to produce aluminum sulfate hydrate; and (e) adding the aluminum sulfate hydrate produced in step (d) to the wastewater of step (a) and/or to another wastewater.

The wastewater in the supplying step (step (a)) may be any wastewater that contains aluminum. Additionally, the aluminum in the wastewater may be present in any form. For example, the aluminum contained in the wastewater may be in oxide form and/or hydroxide form.

In one embodiment, the wastewater supplied as a feed may have an aluminum content of 15 wt % or more. Specifically, the wastewater may have an aluminum content of at least 15 wt %, preferably at least 20 wt %, and more preferably at least 30 wt %. Since the wastewater may have a high aluminum content, boehmite in the wastewater may be highly pure.

In one embodiment, the aluminum waste may include boehmite (AlOOH). As described below, the aluminum waste contained in the wastewater can be generated into aluminum sulfate hydrate, which can be used as a coagulant by the process of the present disclosure. In particular, aluminum sulfate hydrate is typically obtained by the Bayer process in which sulfuric acid is reacted with alumite (Al(OH)₃), which is obtained by reacting an aluminum-containing compound such as bauxite with NaOH and crystallizing the reaction product. Therefore, the composition of the waste is not particularly limited as long as the waste contains aluminum. On the other hand, boehmite can be converted to aluminum sulfate hydrate by direct reaction with sulfuric acid without going through the Bayer process described above. Therefore, in terms of process simplification and cost reduction, the aluminum waste may include boehmite.

The process includes step (b) of separating the wastewater into a liquid component and a sludge component containing aluminum. The step is a process of separating the wastewater into a liquid component and an aluminum-containing sludge component which is used to produce aluminum sulfate hydrate. The separation method is not particularly limited. For example, the separation may be performed by centrifugation. In an embodiment, the separation may be performed by adding a coagulant, stirring, and precipitating the sludge component. The liquid component may contain insoluble suspended solids and a trace amount of residual aluminum which has not been separated in the sludge component. The liquid component may be processed in a separate wastewater treatment plant and then be discharged.

In one embodiment of the present disclosure, the sludge component may contain 40 wt % or more of aluminum. The sludge component may contain more than 40 wt % of aluminum. In other words, the sludge component may contain more than 90 wt % or more of boehmite. Such a high boehmite content can increase the yield of aluminum sulfate obtained from the sludge component in later stages. The aluminum content of the sludge component may be 45 wt % or more. In an embodiment, the aluminum content of the sludge component may be 50 wt % or more.

According to one embodiment of the present disclosure, the step of separating the wastewater into a liquid component and a sludge component may involve adding externally sourced aluminum sulfate hydrate to the wastewater. As described above, the step of separating the wastewater into a liquid component and a sludge component may be performed by adding a coagulant to settle and separate the sludge component. Here, aluminum sulfate hydrate may be used as a coagulant. The aluminum sulfate hydrate used in this step may be externally sourced aluminum sulfate hydrate rather than aluminum sulfate hydrate generated from aluminum waste present in the wastewater. The externally sourced aluminum sulfate hydrate may be added to the wastewater at any point in time. For example, the externally sourced aluminum sulfate hydrate may be added to the wastewater at any of stages (a) to (d) of the process, i.e., before step (e) takes place. Alternatively, the externally sourced aluminum sulfate hydrate may be added to the wastewater as an additional coagulant after the aluminum sulfate hydrate generated from aluminum waste present in the wastewater is introduced into the wastewater (step (e)) to further promote coagulation and separation of the sludge component.

The process includes step (c) of mixing sulfuric acid with the sludge component to produce aluminum sulfate. Aluminum, especially boehmite, contained in the sludge component reacts with the sulfuric acid and to produce aluminum sulfate according to the following Reaction Formula 1:

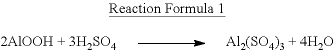

There is no limitation on the method of reacting the sludge component with sulfuric acid, but in terms of increasing the reaction rate by facilitating contact between the sludge component and sulfuric acid, step (c) may involve stirring. The aluminum sulfate produced by the reaction exists as a supernatant in a mixture of the sludge component and the sulfuric acid. That aluminum sulfate can be recovered by separating only the supernatant from the mixture.

In one embodiment of the present disclosure, the step of reacting the sludge component with sulfuric acid may be carried out with the use of a sulfuric acid solution having a concentration of 1 M at a temperature of 60° C. to 100° C. for 1 to 5 hours. The sulfuric acid solution with a concentration of 1 M may be used for convenience in constructing process equipment.

When the temperature is lower than 60° C. in the step of reacting the sludge component with sulfuric acid (step (c)), the heat required to drive Reaction Formula 1, an endothermic reaction, is sufficient, thus decreasing the yield of aluminum sulfate. When the temperature is higher than 100° C., the reverse reaction of Reaction Formula 1 occurs, decreasing the yield of aluminum sulfate. In one embodiment, the step of reacting the sludge component with sulfuric acid may be performed at a temperature of 65° C. to 90° C. In another embodiment, the step of reacting the sludge component with sulfuric acid may be performed at a temperature of 70° C. to 80° C.

The step of reacting the sludge component with sulfuric acid (step (c)) may be performed for 1 to 5 hours. When the reaction time is shorter than 1 hour, the time for mixing the sludge component with sulfuric acid is not sufficient, resulting in poor yield of aluminum sulfate. In addition, when the reaction time is longer than 5 hours, the process cost increases significantly, resulting in poor process cost for the yield of aluminum sulfate. In this step (c), the reaction time may be 2 to 4 hours. In an embodiment, the reaction time may be 2.5 to 3.5 hours.

In one embodiment, the amount of the sludge component relative to the weight of the sulfuric acid solution may be in a range of 5 to 15 wt %. When the amount of the sludge component is less than 5 wt % relative to the weight of the sulfuric acid solution, a large amount of unreacted sulfuric acid solution remains, which reduces reaction efficiency. When the amount is more than 15 wt %, stirring is difficult and requires excessive energy. In the step of reacting the sludge component with sulfuric acid (step (c)), the amount of the sludge component may be 7 to 12 wt %, based on the weight of the sulfuric acid solution. In an embodiment, the amount of the sludge component may be 8 to 11 wt %, based on the weight of the sulfuric acid solution.

The process includes step (d) of mixing the aluminum sulfate with an alcohol to produce aluminum hydroxide hydrate. The aluminum sulfate produced by Reaction Formula 1 is insoluble in alcohol. Therefore, when aluminum sulfate and alcohol are mixed, precipitation occurs to produce aluminum sulfate hydrate, which is a solid phase. More specifically, when aluminum sulfate and alcohol are mixed, aluminum sulfate precipitates in the form of an anhydride (Al₂(SO₄)₃) and water. As the water binds to the anhydrous aluminum sulfate during the precipitation, aluminum sulfate hydrate (Al₂(SO₄)₃·xH₂O) is produced. Aluminum sulfate can be used as a coagulant, but aluminum sulfate hydrate, which is a more concentrated form produced by precipitation, is superior to aluminum sulfate in terms of coagulation ability.

According to one embodiment, in the step of mixing aluminum sulfate with the alcohol (step (d)), the alcohol may be ethanol, propanol, butanol, or combinations thereof. Since the hydrated aluminum sulfate is insoluble in alcohol, alcohol can be used to convert aluminum sulfate to aluminum sulfate hydrate. Ethanol may be used to save the cost of step (d).

According to one embodiment, in the step of mixing aluminum sulfate with alcohol (step (d)), the volume ratio of the aluminum sulfate to the alcohol may be in a range of from 1:2 to 1:5. The volume ratio described above is advantageous for efficient generation and precipitation of aluminum sulfate hydrate. Specifically, the volume ratio of the aluminum sulfate to the alcohol may be in a range of 1:2 to 1:5. In an embodiment, the volume ratio of the aluminum sulfate to the alcohol may be in a range of 1:3 to 1:4.5, or in a range of 1:3.5 to 1:4.5.

The process further includes step (e) of adding the aluminum sulfate hydrate produced in step (d) to the wastewater of step (a). As described above, when the aluminum sulfate hydrate is supplied to the wastewater, the aluminum sulfate hydrate serves as a coagulant which neutralizes the surface charge of organic and inorganic colloidal particles contained the wastewater, so that the colloidal particles can be easily coagulated and settled. In this way, the aluminum sulfate hydrate can remove colloidal particles contained in the wastewater.

The aluminum sulfate hydrate added to the wastewater in step (e) is obtained by using aluminum contained in the wastewater as a raw material. Therefore, the process of the present disclosure can remove waste, particularly aluminum-containing waste, from wastewater while minimizing the usage of externally sourced coagulants, thereby enabling a cost-effective wastewater treatment.

In one embodiment, in the step of adding the aluminum sulfate hydrate to the wastewater (step (e)), the amount of the aluminum sulfate hydrate added to the wastewater may be 10 to 300 ppm relative to the mass of the wastewater. In one embodiment, the generated aluminum sulfate hydrate (the aluminum sulfate hydrate produced in step (d)) is introduced into the wastewater in the presence of externally sourced aluminum sulfate hydrate. In this case, it is possible to reduce the usage of externally sourced aluminum sulfate hydrate that is used to coagulate and remove the sludge component containing aluminum.

In one embodiment, the process may further include the step of supplying the aluminum sulfate hydrate to a separate wastewater treatment plant. The liquid component separated from the wastewater in step (b) may contain insoluble suspended solids as well as a trace amount of residual aluminum that has not been separated as the sludge component. That liquid component may be fed to the separate wastewater treatment plant; and the aluminum sulfate hydrate produced in step (e), as a coagulant, may also be fed to that separate plant to coagulate and remove the residual aluminum and insoluble suspended solids.

In other words, the process of the present disclosure minimizes the amount of an externally sourced coagulant, and generates aluminum sulfate hydrate, which can be used as a coagulant, from aluminum waste contained in wastewater, thereby enabling value-added waste recycling. The process of the present disclosure is a two-stage wastewater treatment process in which wastewater is first separated into a liquid component and a sludge component, and the liquid component is subsequently further processed in a separate wastewater treatment plant. Therefore, the process of the present disclosure can increase the efficiency of waste removal from the wastewater. Furthermore, since the coagulant supplied to the wastewater treatment plant is the aluminum sulfate hydrate generated from aluminum waste contained in wastewater, the process of the present disclosure can considerably reduce the cost of wastewater treatment.

Hereinafter, various embodiments will be described to aid understanding of the present disclosure. However, the following examples are provided only to facilitate understanding of the present disclosure, and the present disclosure is not limited thereto.

### EMBODIMENT

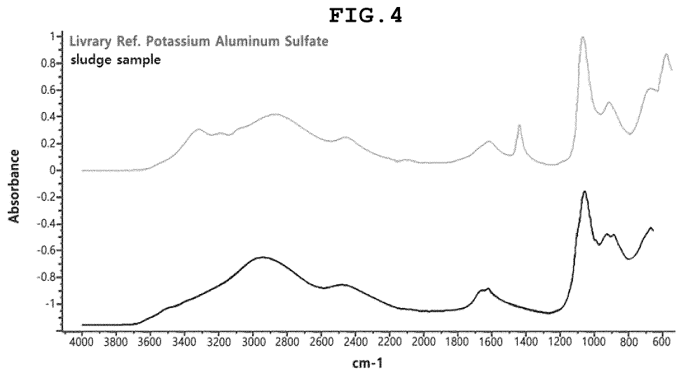

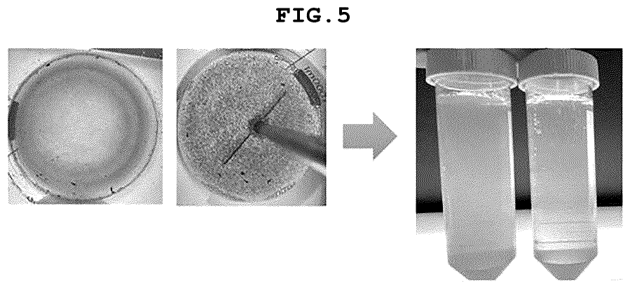

A process for removing aluminum waste contained in wastewater according to one embodiment of the present disclosure was performed at a laboratory scale in the sequence shown in FIG. 2. Raw wastewater containing 43% by mass of aluminum in the form of boehmite (AlOOH) was separated, by centrifugation, into a liquid component and a sludge component containing the boehmite. The sludge component was reacted with 1 M of sulfuric acid solution at a temperature of 80° C. The amount of the sludge component, which is a reactant, added to the 1 M of sulfuric acid solution was 20 wt %, and the reaction time was 1 to 3 hours. Referring to FIG. 3, it is possible to visually observe the difference in the amount of aluminum sulfate hydrate produced when the time for reaction between the sludge component and the sulfuric acid solution was varied to 1 hour, 2 hours, and 3 hours (from left to right). The FTIR analysis results of the sludge component containing aluminum sulfate hydrate obtained through reaction between the sludge component and the sulfuric acid are shown in FIG. 4. The results show a peak similar to the peak of the FTIR analysis of potassium aluminum sulfate (see the lower graph in FIG. 4). After reaction with the sulfuric acid, the sludge component containing aluminum sulfate was mixed with ethanol in a volume ratio of 1:4 and left for 24 hours to precipitate aluminum sulfate hydrate. The precipitate, i.e., aluminum sulfate hydrate, was added to distilled water to prepare an aluminum sulfate hydrate solution with a concentration of 60 g/L. The solution exhibited a pH of 1.6 and was added to wastewater. The feed concentration of the aluminum sulfate hydrate added to the wastewater was approximately 120 ppm by mass. The wastewater into which the aluminum sulfate hydrate solution was added was stirred at 180 rpm for 3 minutes and then stirred at 50 rpm for 3 minutes. The appearance of the raw wastewater and treated water was observed, and the results are shown in FIG. 5. That is, the images of the water observed before and after the addition of the aluminum sulfate hydrate solution are shown in FIG. 5.

As illustrated in FIG. 5, the raw wastewater (left column) was overall turbid when visually observed, while the wastewater treated with the aluminum sulfate solution (right column) was relatively transparent compared to the raw wastewater because suspended solids were coagulated to form agglomerates.

Herein above, the present disclosure has been described in detail with reference to specific embodiments. Embodiments are intended to illustrate the present disclosure in detail, and the present disclosure is not limited thereto. It will be apparent to those skilled in the art that modifications thereto or improvements thereof are possible within the technical spirit of the present disclosure.

All simple modifications and alterations of the present disclosure fall within the scope of the present disclosure, and the specific protection scope of the present disclosure will be clearly defined by the appended claims.

What is claimed is:

1. A process of removing aluminum waste from wastewater, the process comprising:
(a) supplying, as a feed, wastewater containing aluminum;
(b) separating the wastewater into a liquid component and a sludge component containing the aluminum;
(c) reacting the sludge component with sulfuric acid to produce aluminum sulfate;
(d) mixing the aluminum sulfate with an alcohol to produce aluminum sulfate hydrate; and
(e) adding the aluminum sulfate hydrate produced in step (d) to the wastewater of step (a) and/or to another wastewater.

2. The process of claim 1, wherein the wastewater in step (a) has an aluminum content of more than 15 wt %.

3. The process of claim 1, wherein the aluminum waste comprises boehmite (AlOOH).

4. The process of claim 1, step (b) comprises adding externally sourced aluminum sulfate hydrate to the wastewater.

5. The process of claim 1, wherein step (c) is performed with a sulfuric acid solution having a concentration of 1 M and at a temperature of 60° C. to 100° C. for 1 to 5 hours.

6. The process of claim 5, wherein the sludge component is added in an amount of 5 to 15 wt % based on the weight of the sulfuric acid solution.

7. The process of claim 1, wherein in step (d) the alcohol comprises ethanol, propanol, butanol, or a combination thereof.

8. The process of claim 1, wherein in step (d), the aluminum sulfate and the alcohol are mixed in a volume ratio of 1:2 to 1:5.

9. The process of claim 1, wherein in step (e), the aluminum sulfate hydrate is added in an amount of 10 to 300 ppm relative to the mass of the wastewater.

10. The process of claim 1, the another wastewater is in a separate wastewater treatment plant.

11. The process of claim 3, wherein step (c) includes mixing the sludge component reacts with the sulfuric acid according to the following Reaction Formula 1: [chemical structure]
